(19) United States
(12) Patent Application Publication
(10) Pub. No.: US 2014/0228071 A1
(43) Pub. Date: Aug. 14, 2014

(54) METHOD TO SWITCH SUBSCRIPTIONS OF A PERSONAL DEVICE SUPPORTING MULTIPLE SUBSCRIPTIONS

(71) Applicants: Luis Villarrubia Grande, Madrid (ES); Jose RelanoGil, Madrid (ES); Jorge Blanco Aparicio, Madrid (ES)

(72) Inventors: Luis Villarrubia Grande, Madrid (ES); Jose RelanoGil, Madrid (ES); Jorge Blanco Aparicio, Madrid (ES)

(73) Assignee: TELEFONICA, S.A., Madrid (ES)

(21) Appl. No.: 14/119,964

(22) PCT Filed: Dec. 16, 2011
(86) PCT No.: PCT/EP2011/073047

§ 371 Date: Jan. 29, 2014

(30) Foreign Application Priority Data
May 27, 2011 (ES) P201130875

(51) Int. Cl. H04W 8/18; H04W 88/06

(52) U.S. Cl. CPC H04W 8/18; H04W 88/06
USPC 455/552.1

(57) ABSTRACT

The method comprises performing said subscription switching automatically based on a generated event. Said event is generated by an application running on top of the operating system of said personal device, said event containing encoded information to perform said subscription switching. Said event is captured by the Universal Integrated Circuit Card of the personal device, which switches the active subscription to a new subscription.

The method further comprises analyzing the contents of the Terminal Profile message sent to the UICC in its initialization to discover the capabilities supported by said personal device, which will determine the events that can be captured by the UICC.

### FIELD OF THE ART

The present invention generally relates to a method to switch subscriptions of a personal device supporting multiple subscriptions and more particularly to a method which comprises performing said subscription switching automatically based on an event generated by an application of said personal device and captured by the Universal Integrated Circuit Card of said personal device.

### PRIOR STATE OF THE ART

Mobile Phone applications and applications located in the Universal Integrated Circuit Card (UICC) represent disjointed programming environments, as they make use of different programming technologies and were originally designed to execute independent software. This is reinforced by the fact that they don't even share the execution processing unit, as mobile applications and mobile software are executed in different CPUs:
mobile device CPU: ARM processor in case of application layer software and other Chipset low level CPUs, ASICs or DSPs in case of mobile communication software
applications running on UICCs (also referred as applets) make use of the integrated CPU of the Smartcard.

The independence of both environments includes the use of different programming technologies for each case, as for example javacard for applications running on UICCs, which is a technology that is not used at all for the case of mobile device applications.

For the purpose of communicating both execution environments, Application Programming Interfaces (APIs) must be defined, comprising those functionalities implemented between the mobile device and the UICC. APIs are normally demanded by mobile applications in order to access functionalities managed by UICCs, that are otherwise non accessible for those entities.

In order to provide those APIs it is normally required the device manufacturer to facilitate the creation of “communication” channels between both environments as well as some degree of support of the Operating System and the programming execution environment of the mobile applications for its implementation.

Regarding the support of more than one subscription in a single SIM card, standard specifications reflect this possibility as it can be found on [1], wherein the chapter 8 specifies:

“If a UICC contains more than one USIM application, these are normally related to separate subscriptions, either from the same or from different network operators. In that case IMSIs and secret keys are different and cannot be shared. The authentication algorithm may be shared if the nature of the subscriptions does not require different algorithms. Concerning the mapping of files between multiple USIMs, only the following guidelines can be given:
If the UICC is intended to be used by a single user, all user relevant files (that can be updated by the user) could be mapped. The phonebook will preferably be located under DF TELECOM, to enable global access from all applications. In a multi-user model, user relevant files should not be mapped and a specific phonebook will be under each DF USIM.
All directly subscription relevant files (like Kc or MSISDN) or those needed to differentiate the subscriptions should not be mapped.
All other files: Mapping depends on conditions of use in a multi-subscription environment.

If a SIM application is existing in addition to multiple USIM applications, mapping can be done according to section 7 and Annex C with one of the USIM applications.

As it is not possible to cover all specific situations that might require multiple USIMs on a UICC, such design decisions should be taken on a case by case basis by considering each data field and its possible use.”

In the literature it can be found the invention “Wireless device with a single SIM operating though it had two or more different SIMs” [2] where it is described the invention related to having more than a single subscription in a single UICC card.

In the referred document it is described that the device has a proprietary application module (PAM) controlling switching between a local subscriber identity module (SIM) and a roaming SIM module, where switching is done by an end user operating the switch. A SIM control unit controls the local SIM (LS) sub module and the roaming SIM (RS) sub module. The SIM control unit stores a PIN associated with each local and roaming sub modules, and selects the local SIM sub module as a default when powered on. The local SIM sub module and the roaming SIM sub module are sub modules within the single SIM.

Despite the rationale behind[2], the object of the invention seems to be the cost saving (“It enables incoming and outgoing SMS, voice and data calls to be routed cost effectively and flexibly”). Moreover, it is a constant along the description of the invention the existence of proprietary modules in order to handle the logic and transitions between subscriptions. It is reasonable therefore to assume that some degree of integration with the device manufacturer might be required, despite the fact that there is no description of the detailed mechanisms by which this might be accomplished. The way the mobile device communicates with the subscription module in the UICC is not described therein.

The invention described in “A method where communication parameters on a mobile communication device (subscription) and a mobile communication device in which the method maybe carried out” [3] tries to detail the logic behind the previous selection of the most suitable set of communication parameters (subscription) according to the communication task (communication destiny, lower tariff, access granted, type of communication; voice, data, SMS . . . ) and the looking tables in order to perform and execute the communication with the new associated subscription. Again it is not focused in the implementation of any specific mechanism in order to accomplish how the mobile device will communicate with the UICC in order to perform that change of parameters.

Even if both inventions are based in some degree on the “capability” of switching between subscriptions by a mobile device, they do not specify or give any basics on the method by which this functionality might be accomplished.

Other approaches to multiple Subscriptions handling in mobile devices are described next:
DUAL SIM Card: allows two numbers in one SIM card (special purpose SIM card), allowing customers to combine for example a corporate number and a personal number in the same mobile device. At every moment only one of the profiles/subscription is active, being the calls automatically diverted from one line to the other (non-active to the active line) in order not to miss any of the incoming calls.

Dual SIM card have a mandatory corporate PIN and personal PIN. The user chooses at each moment the line he wants to use by accessing a SIM card menu and introducing the corresponding PIN.

It is not normally required to switch off and on the device in order to perform the line swapping, depending on the mobile device HW. Another benefit from the product is that the user enjoys two independent Voice Box, one for each of the lines.

DUAL SIM card is a specific purpose type of SIM card with a different architecture form what is known as a standard SIM Card (the one normally provided to be used in a mobile phone)
Dual SIM mobile phone is a mobile device capable of holding two SIM cards. Initially, dual-SIM adapters were made available to use in regular mobile phones to allow them to contain two SIMs, and to switch from one to the other as required. More recently, some phones have been produced that can natively work with two SIMs, both of which may be active or not at the same time (if yes, a Dual transceiver is required).
Second Line/Virtual number: is a network configured service that can associate a secondary additional number to a basic mobile number (line). It requires to the user to dial a predefined prefix number previous to the destiny number in order to indicate to the system that the second line is the performing the call. The same prefix will prompt as a prefix of the incoming call number to indicate the user that somebody is calling that second number.

Problems with Existing Solutions

DUAL SIM Card requires the use of a specific type of SIM card with all the disadvantages this might imply:

1. Need of replacement of current SIM cards from the user. Even if users changes from time to time of mobile phone, the SIM card normally remains the same for very long periods of time (replacement normally associated to number change)

2. Support of the DUAL SIM card by the phone.

3. Proprietary implementation what makes it difficult to evolve and implement new standardization features.

4. Explicit access to the UICC application by the user that must enter into the SIM toolkit menu to command the switch of subscription, involving the reintroducing of the PIN number associated to the new active subscription.

Regarding Dual SIM mobile phone, there are different approaches in the way that a unique mobile device can support more than one physical SIM card.

In the case of using an external adapter for allocating two SIMs, the whole system can be considered as a homemade gadget with no guarantee from the device manufacturer about proper functioning. It could be even argued the breach of contract that in many cases the use of multiple SIM cards on a single device might imply.

Some adapters require the two SIM cards to be cut to size, fitted onto a special holder and are inserted into the phone's SIM socket; this can be quite risky, since the user might end up damaging the SIM card in the process.

For the case of Mobile devices supporting two SIM cards (two SIM cards slots) it must be highlighted the extremely reduced portfolio of those devices, and the fact that until very recent major brands have not offered this kind of products.

It must also be highlighted than none of those products are available in Europe or North America with, apparently, no plans from recognized companies to start its distribution

Another drawback of such devices is the lack of the standardization needed to guarantee the correct performance of the features associated to the implementation of using two SIM cards in one device.

### DESCRIPTION OF THE INVENTION

It is necessary to offer an alternative to the state of the art which covers the gaps found therein, particularly related to the lack of proposals which really provides a smooth transition between subscriptions with no need to introduce the PIN when changing from one number to the other, or with no need to restart the device.

To that end, the present invention provides a method to switch subscriptions of a personal device supporting multiple subscriptions. On contrary to the known proposals, the method of the invention, in a characteristic manner it further comprises, performing said subscription switching automatically based on a generated event. Said event is captured by the Universal Integrated Circuit Card of the personal device, which switches the active subscription to a new subscription.

The main objective of this invention, sharing the idea of switching between subscriptions, is the description of a method for its implementation, independent of the phone manufacturer as it is based on current standard phone capabilities. The detailed of the description enables the implementation without any manufacturer involvement, being in practice independent of the mobile device hardware platform.

Other embodiments of the method of the first aspect of the invention are described according to appended claims 2 to 11, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows current communication channel establishment between mobile applications and STK applets (UICC applications).

FIG. 2 shows the switch subscription flow in the UICC, according to an embodiment of the present invention.

FIG. 3 shows the Terminal Profile structure.

FIG. 4 shows the flow diagram when an event generated by a mobile application is captured by the UICC and it performs the switch subscription procedure, according to an embodiment of the present invention.

FIG. 5 shows the interaction between the entities involved in the method when a subscription switching is performed, according to an embodiment of the present invention.

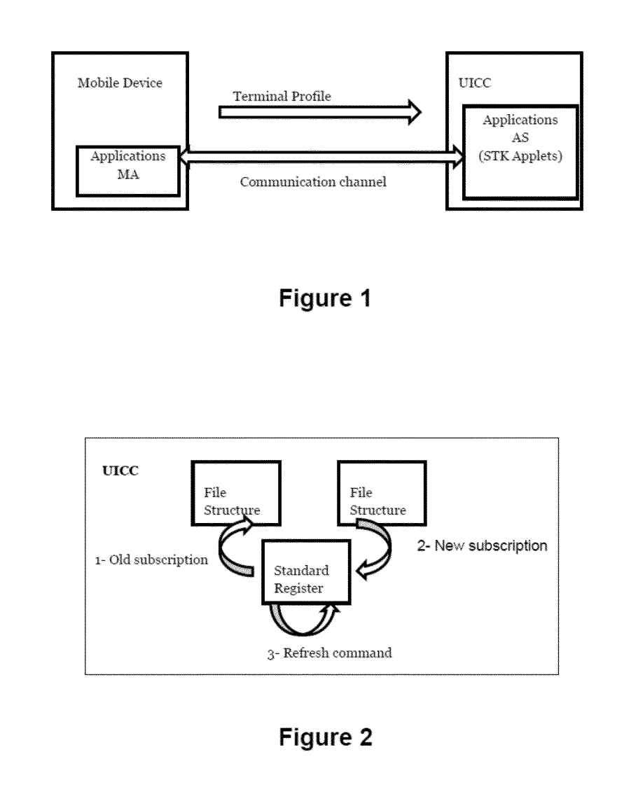

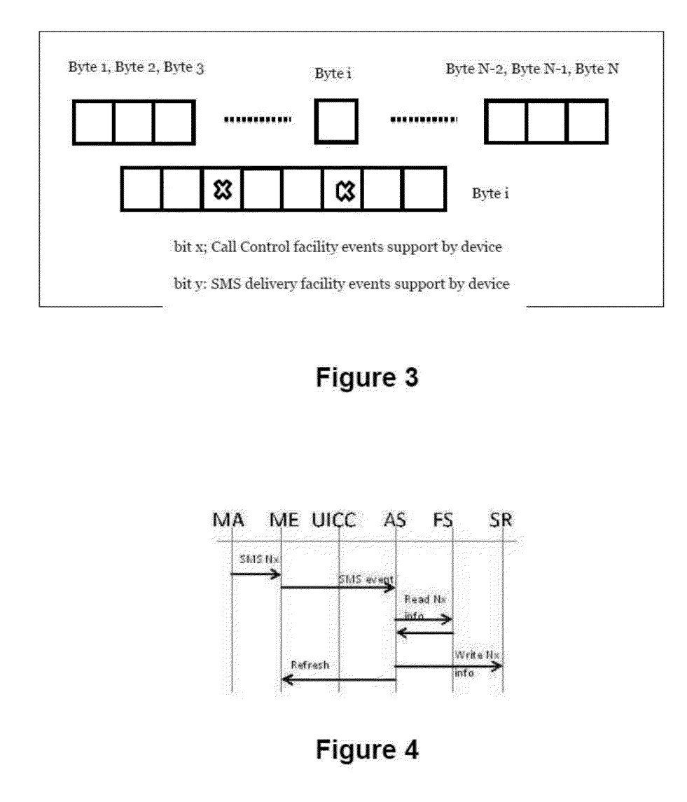

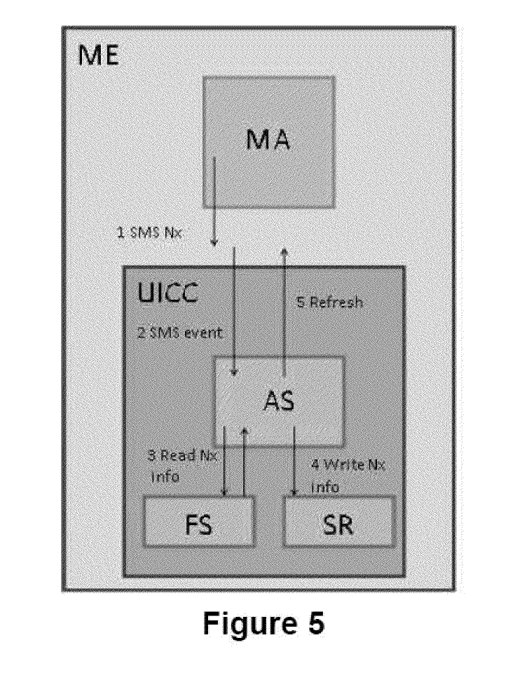

### DETAILED DESCRIPTION OF SEVERAL EMBODIMENTS

The basic concept of the invention is the description of a method to communicate the applications of a mobile device running on top of the operating system with the applications, data and any element stored on the UICC or SIM Module in order to manage subscriptions and to perform a switch in the active subscription among the potential multiple subscriptions (two or more) available in a UICC or SIM module.

The whole procedure consists therefore of a mobile application running on a mobile device, capable of invoking any of the procedures or events described next, events that can be captured by an application running on the UICC and selected according to the capabilities supported by the device (based on the analysis of the contents of the standard Terminal Profile message sent by the mobile device to the UICC in its initialization). Those procedures or events generated by the mobile device application are captured by an application running on the UICC card and contain the information encoded required to perform subsequent actions to switch the active subscriptions, among the multiple (two or more) subscriptions stored in the file register structure of the UICC.

As it has been previously stated, traditionally UICC applications and mobile device applications can be considered as disjointed worlds, so Applications Programming Interfaces (APIs) must be provided in order to provide access capabilities related with the subscription handling. As it is the case that mobile devices where originally invented to handle only one subscription in a SIM module, it is extremely difficult if not impossible to provide a mechanism to manage both subscriptions in case of being implemented in a single UICC card, even in the case there exist a SIM access API (as they were originally designed to access a single subscription).

Applications available in the UICC can be accessed through a mobile device menu, meaning that the accessed application is executed inside the UICC while the user interface or menus are displayed in the mobile device screen. The initial trigger for the application of the UICC must be initiated by the user, acting explicitly to launch the UICC application (and optionally an associated menu) that will allow the switching between available subscriptions. The real challenge of this invention is the “seamless communication” between the Mobile application and the UICC application; in a way they can share parameters to command the switching and subsequent actions, without the initial user intervention invoking the UICC application.

This invention also allows the automatic switching of subscriptions commanded by a mobile device application running on a mobile device, in the case that predefined conditions are satisfied. Those conditions might attend to different context aware variables like location, time schedule, tariff and cost of communication associated to time schedule, location or any other consideration, coverage requirements, access restrictions to determined types of services or user/subscription limitations, preferred access type, black/grey lists, security restrictions or any other predefined criteria that would justify the use of a different subscription to the one currently active.

The logical elements involved in the whole process are described next:
Mobile Equipment (ME): Entity where the mobile application is executed, usually the mobile device
Universal Integrated Circuit Card (UICC): Entity where the Applet STK is executed, usually a smart card.
Mobile Application (MA): Is the logical entity that will be in charge of triggering the event associated to the commutation between subscriptions.
Applet STK (AS): Is the logical entity or application responsible of receiving the event that triggers the commutation and that process the information contained in that event in order to perform the switch of the subscription. It also known as the UICC application.
File Structure (FS): Set of entities responsible of maintaining the data associated to each of the subscriptions.

The general principle that drives the design of the invention is the management of events from the STK framework (SIM tool Kit) that are potentially generated or launched by a Mobile Application (MA), in a way that they don't involve additional user interaction (beyond an initial single click from the user interface to command the action itself at Mobile Application level). It is also important to highlight that there is therefore no need of generating a visual response (such as a menu or user input required box) as the event generated contains all the data required for the communication between the mobile application (MA) and the entity (AS) in charge of performing the switch of the subscription.

The whole procedure is initiated by the reception in the UICC card of the standard Terminal Profile message sent by the Mobile Device. Terminal Profile is a standard instruction sent by the mobile device to the UICC as part of the UICC initialization, containing a set of facilities supported by the mobile device in order to communicate with the UICC and that will be the basis of the method described in this invention.

The use of those facilities supported by the mobile is the key element in which it will be based the communication channel opened between a mobile application (MA) and the UICC applications (AS).

The subscription switching process in the UICC card will be performed by substituting the standard registry entries of the active subscription by those associated to the new subscription, followed by the activation of the new subscription based on a refresh action. Standard registry entries are those that contain the set of parameters that constitute the active subscription and that allow the communication between the mobile device and the network, including the initial registration procedure.

1. Available set of subscriptions are maintained in the UICC File structure. The logical steps in order to switch the subscription can be summarized as follows:

2. Current active subscription is loaded to the File structure if not already allocated a permanent location on it.

3. New subscription commanded by the mobile application is loaded in the Standard Registry.

Refresh action is performed in order the mobile device to take into account the new set of parameters of the new subscription, involving a new registry between the mobile and the network.

Among the events candidates to be captured by the STK framework (STK applet also referred as UICC application) it must be highlighted those associated to Call Control and SMS delivery. Both type of events can be triggered by the Mobile Application (MA) without any subsequent user interaction and can be post processed by the UICC entity (AS), including the information encoded in the event itself as parameters that will determine the flow of subsequent actions to be executed.

In the case of the device supporting facilities of events associated to Call Control, an implementation for the creation of a communication channel between the mobile application (MA) and the UICC application will be based on the use of events associated to Call Control. Operations associated to call control are those associated to invoking a call, so the encoding of the subsequent actions that must be performed by the UICC application must be univocally contained and coded in the phone number introduced as parameter of the invoked call. As this can be considered a non user call invocation, but an internal application level procedure, no dialer screen prompts in the user device screen and no real call is performed, so no interchange of information or signaling occurs between the mobile device and the network.

In the case of using events related to SMS delivery the required information to indicate the subsequent action might be included in both the destiny telephone number and/or the body of the intended SMS. Again no user interface related to SMS delivery is invoked in the mobile equipment and no subsequent delivery of SMS or interchange of information or signaling between the mobile device and the network is carried out.

Events associated to USSD, SS, PDP are also candidates to be used as potential events to be captured by the UICC when the proper required actions are performed by mobile applications. The relationship between them and previous referred type of events can also be found in the standards:
Call control by USIM [9]: when this service is activated by the USIM, all dialed digit strings, supplementary service control strings and USSD strings or PDP context parameters are first passed to a USIM application before the ME sets up the call, the supplementary service operation or the USSD operation or establishes the PDP context. The ME shall also pass to the USIM application at the same time its current serving cell. The USIM application has the ability to allow, bar or modify the call, the supplementary service operation or, the USSD operation or PDP context activation by another context activation. The USIM application also has the ability to replace a call request, a supplementary service operation or a USSD operation by another call request or supplementary service operation or USSD operation.
MO Short Message control by USIM [9]: When this service is activated by the USIM, all MO short messages are first passed to the USIM application before the ME sends the short message. The ME shall also pass to the USIM application at the same time its current serving cell. The USIM application shall have the ability to allow the sending, bar the sending or modify the destination address of the short message before sending it.

It must be clarified that in any of the afore mentioned procedures there is no real call or SMS delivery to the network, as the associated telecommunication procedure is aborted of progressing any further with the only purpose of establishing a communication channel between the Mobile Application (MA) and the entity performing the management of subscriptions (AS), otherwise totally isolated in the absence of specific APIs to establish communication between them.

Terminal Profile Analysis

Terminal Profile is a standard instruction sent by the mobile device to the UICC as part of the UICC initialization, containing a set of facilities supported by the mobile device in order to communicate with the UICC and that will be de basis of the method described in this invention.

The first procedure in order to implement the communication between the device and the (X)SIM is therefore to analyse the terminal profile command ([4] [5] [6] [7] [9]) interchanged between the ME and the UICC. Based on the facilities supported by the ME, one of other types of messages will be selected to implement the protocol of interchanging commands between the Mobile Applications (MA) and the Applet STK (AS).

The profile download instruction is sent by the terminal to the UICC as part of the UICC initialization procedure and as soon as possible when SAT functionality is modified in the terminal. This procedure is specified in [5] [6] for a 3G platform and in [5] [10] for a 2G platform. The profile sent by the terminal shall state the facilities relevant to SAT that are supported by the terminal.

This procedure is important, as it allows the UICC to determine what the terminal is capable of, and the UICC can then limit its instruction range accordingly. If no command is sent by the terminal, the UICC shall assume that the terminal does not support SAT.

In the structure and coding of the terminal profile several bits may need to be set to 1 for the support of the same facility. This is because of backward compatibility with SAT: several options existed in SAT for a given facility, and they are mandatory in USAT when this facility is supported. According to that, the bytes of this structure are specified next:
First byte (Download):
   b1: Profile downloaded. See ETSI TS 102 223 [7]
   b2: SMS-PP data download
   b3: Cell Broadcast data download
   b4: Bit=1 if SMS-PP data download is supported
   b5: Menu selection. See ETSI TS 102 223 [7]
   b6: See ETSI TS 102 223 [7]
   b7: Bit=1 if Call Control by USIM is supported
   b8: Bit=1 if Call Control by USIM is supported
Second byte (Other):
   b1: See ETSI TS 102 223
   b2: Call Control by USIM
   b3: Bit=1 if Call Control by USIM is supported
   b4: Bit=1 if Call Control by USIM is supported
   b5: See ETSI TS 102 223
   b6: See ETSI TS 102 223
   b7: See ETSI TS 102 223
   b8: MO short message control by USIM
Third byte (Proactive UICC): See ETSI TS 102 223.
Fourth byte (Proactive UICC):
   b1: See ETSI TS 102 223
   b2: Proactive UICC: SEND SHORT MESSAGE
   b3: Proactive UICC: SEND SS
   b4: Proactive UICC: SEND USSD
   b5: See ETSI TS 102 223
   b6: See ETSI TS 102 223
   b7: See ETSI TS 102 223
   b8: See ETSI TS 102 223
Fifth byte (Event driven information): see ETSI TS 102 223.
Sixth byte (Event driven information extensions): see ETSI TS 102 223.
Seventh byte (Multiple card proactive commands) for class “a”: see ETSI TS 102 223.
Eight byte (Proactive UICC):
   b1: See ETSI TS 102 223
   b2: See ETSI TS 102 223
   b3: See ETSI TS 102 223
   b4: See ETSI TS 102 223
   b5: See ETSI TS 102 223
   b6: See ETSI TS 102 223
   b7: See ETSI TS 102 223
   b8: Bit=1 if Call Control by USIM is supported
Ninth byte:
   b1: See ETSI TS 102 223
   b2: See ETSI TS 102 223
   b3: See ETSI TS 102 223
   b4: See ETSI TS 102 223
   b5: Proactive UICC: PROVIDE LOCAL INFORMATION (Timing Advance)
   b6: See ETSI TS 102 223
   b7: See ETSI TS 102 223
   b8: See ETSI TS 102 223
Tenth byte (Soft keys support) for class “d”: see ETSI TS 102 223.
Eleventh byte: (Soft keys information): see ETSI TS 102 223.
Twelfth byte: see ETSI TS 102 223.
Thirteenth byte: see ETSI TS 102 223.
Fourteenth byte (Screen height): see ETSI TS 102 223.
Fifteenth byte: (Screen width): see ETSI TS 102 223.
Sixteenth byte: (Screen effects): see ETSI TS 102 223.
Seventeenth byte: see ETSI TS 102 223.
Eighteenth byte:
   b1: Proactive UICC: DISPLAY TEXT (Variable Time out)
      Proactive UICC: GET INKEY (help is supported while b2: waiting for immediate response or variable timeout)
   b3: USB supported by ME
   b4: Proactive UICC: GET INKEY (Variable Timeout)
   b5: reserved for ETSI SCP
   b6: CALL CONTROL on GPRS
   b7: RFU, bit=0
   b8: RFU, bit=0
Nineteenth byte: (reserved for TIA/EIA-136 facilities): see ETSI TS 102 223.
Twentieth byte: (reserved for TIA/EIA/IS-820 facilities): see ETSI TS 102 223.
Subsequent bytes: see ETSI TS 102 223.
Response parameters/data: none.

According to that, potential events that can be used for the implementation of the communication procedure are:

First Byte:
b7: Bit=1 if Call Control by USIM is supported. Reserved by 3GPP (USSD string data object support in Call Control by USIM)
b8: Bit=1 if Call Control by USIM is supported

Second Byte:
b2: Call Control by USIM
b3: Bit=1 if Call Control by USIM is supported
b4: MO short message control by USIM
b5: Bit=1 if Call Control by USIM is supported

Fourth Byte
b2: Reserved by 3GPP (Proactive UICC: SEND SHORT MESSAGE with 3GPP-SMS-TPDU)
b3: Reserved by 3GPP (Proactive UICC: SEND SS)
b4: Reserved by 3GPP (Proactive UICC: SEND USSD)
b5: Proactive UICC: SET UP CALL

Eighth Byte
b8: Bit=1 if Call Control by USIM is supported

Eighteenth Byte
b6: CALL CONTROL on GPRS

Nevertheless, the list referred above must not be considered as an exhaustive list of all the events that in case of being triggered by the mobile application (MA) are susceptible of being captured by the UICC Application (AS) and therefore cannot be considered the only ones that are capable of implementing the procedure referred in this document. It is also worth noting that new releases are constantly appearing reflecting new capabilities that will potentially allow the implementation of this invention, being out of reach to predict future changes in the standards.

Procedure of Capturing the Event by the UICC STK

Without loss of generality and based on the election of one of the candidate events summarized above, it can be found next a proposal of implementation of the present invention based in SMS delivery:

This example will be based on the selection of the event described in the TERMINAL PROFILE Command and which support is indicated by the Fourth Byte, bit 2: “Reserved by 3GPP (Proactive UICC: SEND SHORT MESSAGE with 3GPP-SMS-TPDU)”.

An event responsible of the triggering by the Mobile Application (MA) is defined:
“e_Trigger”: SEND SHORT MESSAGE

By default, this event is generated every time an application in the mobile equipment (ME) sends an SMS. When from an Mobile Application entity (MA) it is intended to perform the switch of the active subscription to any other subscription provisioned in the UICC (2 subscriptions are consistently considered along this procedure, which might be extended to N without loss of generality), it is required to create the SMS delivery to a destiny number “Nx”, (considered like active subscription or not active subscription according to the requirement), which generates the notification of the event “e_Trigger” to the UICC. This event will be subsequently captured by the STK Applet (AS) in the UICC, which will be responsible of performing the following actions:

1. Verification of the destiny number of the SMS. According to the coded information associated to that number, the coded file structure (FS) associated with the selected subscription is loaded in temporary memory.

2. Each of the temporary memory positions must be written on the standard registries (SR) of the UICC. Those standards registries conform the active subscription once it is performed a refresh of the UICC or its initiation.

3. There is a refresh of the subscription trough a proactive refreshing command that makes active the subscription with the new loaded data.

### Advantages of the Invention

No integration with hardware of devices manufacturer in order to implement the invention.
Smooth transition between profiles/subscription. No need of introducing the PIN when changing from one number to the other.
No need of restarting the device when changing from one number to the other.
As it is based in the standard smartcard card UICC, current logistics and scale mass production policies might be applied.
Multiple line number capability can be eventually activated in already shipped SIM cards, over a secure mechanism Over-The-Air (OTA). This implies that there is no need of handling the SIM card or the Mobile device by the Operator, allowing remote activation.
No special designed phone with multiple slots in which insert multiple SIM cards is required (compared with Dual SIM Mobile Solution), as both lines are handled by a single SIM.
No HW adaptation in the phone to allow multiple slots in which insert multiple SIM cards, as the invention makes use of a single SIM.
No use of Multiple UICC card adapters that allow the swap between SIM/UICC cards, as the invention makes use of a single SIM.
High availability of Mobile device portfolio, as the invention can be potentially to any device.

Among the potential Use Cases that will be addressed by the invention it can be highlighted:
Two mobiles in One, with no need of carry two mobiles anymore in order to make and receive calls to two different numbers.
Corporate/Personal lines in the same device can be considered as a more specific applicability of the previous use case. The differentiation of line numbers for corporate and private calls would allow features as the restriction of entry calls when one line is activated (non active SIM contacts would be received if diverting is explicitly allowed by the user)
Differentiated billing associated to two different numbers.
BYOD: Bring your own device. The employee can bring their own device to work, with no need to carry the company device in order to receive corporate calls.

A person skilled in the art could introduce changes and modifications in the embodiments described without departing from the scope of the invention as it is defined in the attached claims.

### ACRONYMS

3GPP 3rd Generation Partnership Project

API Application Programming Interface

API Application Processing Unit

AS Applet STK

CPU Central Processing Unit

DSP Digital Processing Unit

FS File Structure

GPRS General Packet Radio Service

GSM Global System for Mobile communications

HLA High Level Application

IMS IP Multimedia Subsystem

IMSI International Mobile Subscriber Identify

ISIM IMS Subscriber Identity Module

KC Ciphering Key

MA Mobile Application

ME Mobile Equipment

MO Mobile Originated

MSISDN Mobile Subscriber Integrated Services Digital Network Number

OTA Over The Air

PDP Packet Data Protocol, e.g., IP or X25 or PPP

RFU Reserved for Future Use

SAT SIM Application Toolkit

SIM Subscriber Identity Module

SMS Short messaging Service

SR Standard Registries

STK SIM Tool Kit

SS Supplementary Services

SW Software

UICC Universal Integrated Circuit Card

UMTS Universal Mobile Telecommunication System

USAT USIM Application Toolkit

USIM Universal Subscriber Identity Module

USSD Unstructured Supplementary Service Data

(X)SIM SIM/USIM/ISIM

### REFERENCES

[1] ETSI TR 131.900: “SIM/USIM internal and external interworking aspects, 3Gpp TR 131.900 version 9.0.0 Release 9”
[2] GB 2 436 015 A “Wireless device with a single SIM operating though it had two or more different SIMs”
[3] US 2007/0184858A1 “Method of attaching mobile communication tasks to a subscriber information module card and mobile communication device incorporating the same”
[4] 3Gpp (X)SIM standardization: http://www.3gpp.org/ftp/Specs/html-info/31-series.htm
[5] ETSI UICC standardization: http://portal.etsi.org/
[6] ETSI TS 102 221: “Smart Cards; Card Application Toolkit (CAT)”.
[7] ETSI TS 102 223: “Smart Cards; Card Application Toolkit (CAT)”.
[8] 3GPP TS 31.101: “UICC-terminal interface; Physical and logical characteristics”.
[9] 3GPP TS 31.111: “Universal Subscriber Identity Module (USIM) Application Toolkit (USAT)”.
[10] ETSI TS 151 011: “Specification of the Subscriber Identity Module-Mobile Equipment (SIM-ME) interface”

1.-11. (canceled)

12. A method to switch subscriptions of a personal device supporting multiple subscriptions, comprising performing said subscription switching automatically based on a generated event, said multiple subscriptions supported by means of a Universal Integrated Circuit Card, or UICC, said method comprising:
analyzing the contents of a Terminal Profile message sent to the UICC in its initialization to discover said capabilities supported by said personal device;
generating said event by means of an application running on top of the operating system of said personal device, said event containing encoded information to perform said subscription switching; and
communicating said application and said UICC and capturing, said UICC, said event generated by said application according to the capabilities supported by said personal device.

13. A method as per claim 12, comprising performing said subscription switching by means of the UICC by:
loading the active subscription to the File structure;
loading the new subscription in the Standard Registry; and
refreshing the content of the Standard Registry to take into account the new set of parameters related to said new subscription.

14. A method as per claim 12, comprising triggering said generation of said event when at least one condition related to the context aware variables described in the following list is satisfied: location, time schedule, tariff, cost of communication, coverage requirements, access restrictions to determined type of services, preferred access type, black/grey lists and security restrictions.

15. A method as per claim 12, comprising triggering said generation of said event when a user interacts with said personal device by means of a user interface, and said interaction comprises accessing to the UICC.

16. A method as per claim 12, wherein said generated event is associated to at least one of the following procedures: call control, SMS delivery, Unstructured Supplementary Service Data, Supplementary Services and Packet Data Protocol.

17. A method as per claim 16, wherein said encoded information of the event is contained in the phone number introduced as parameter of the invoked call when said event is associated to said call control procedure.

18. A method as per claim 16, wherein said encoded information of the event is encoded in the destiny telephone number and/or the body of and intended SMS when said event is associated to said SMS delivery process.
